(19) United States
(12) Patent Application Publication
(10) Pub. No.: US 2019/0139034 A1
(43) Pub. Date: May 9, 2019

(54) CURRENCY TRANSFER PLATFORM GIVER DEVICE

(71) Applicant: Mezu, Inc., Cleveland Heights, OH (US)

(72) Inventors: Pedro Meunier Gouveia MADEIRA DA SILVA, Alcochete (PT); Yuval BRISKER, Cleveland Heights, OH (US)

(73) Assignee: Mezu, Inc., Cleveland Heights, OH (US)

(21) Appl. No.: 15/805,663

(22) Filed: Nov. 7, 2017

(51) Int. Cl. G06Q 20/38; G06Q 20/32; G06Q 20/42

(52) U.S. Cl. CPC G06Q 20/383; G06Q 20/3224; G10L 13/043; G06Q 20/42; G06Q 20/3223

(57) ABSTRACT

A giver device of a currency transfer platform is disclosed. A first application interface is generated to receive a currency amount to be transferred. A location information corresponding to a geographic location of the giver device associated with an input of the currency amount is determined. The currency amount and the location information are provided to a remote server and in response thereto a transaction code is received. A second application interface is generated and the transaction code is output to the second application interface. One of a first notification that the currency amount was transferred and a second notification that the currency amount was not transferred is received from the remote server.

### BACKGROUND

Currently, the primary, conventional method of anonymously transferring money is to exchange currency in the form of coins or paper bills. In certain cases, however, one party may wish to digitally exchange currency with another party. Typical systems of digital currency transfer may require the parties to exchange personal information (such as email, phone number, bank details, and the like) or personalized information (such as tags, nicknames, and the like) prior to making the transaction. The inventors have recognized that there are many circumstances where parties may wish to digitally exchange currency anonymously. For example, a user may wish to transfer money as a tip to a stranger without exchanging personal information. Thus, a platform for efficient anonymous digital currency transfer would be beneficial.

### BRIEF DESCRIPTION OF DRAWINGS

The foregoing and other features and advantages of the invention will be apparent from consideration of the following, more particular detailed description of various embodiments of the present invention, as illustrated in the accompanying drawings, wherein like reference numbers generally indicate identical, functionally similar, and/or structurally similar elements. The first digits in the reference number indicate the drawing in which an element first appears.

FIG. 1 is a block diagram illustrating an embodiment of a currency transfer platform in accordance with the present invention.

FIG. 2 is a flow diagram illustrating embodiments of a process for transferring currency from a giver device.

FIG. 3 is a diagram illustrating embodiments of an application interface on a giver device for transferring currency.

FIG. 4 is a flow diagram illustrating embodiments of a process for transferring currency at a server.

FIG. 5 is a flow diagram illustrating embodiments of a process for receiving funds.

FIG. 6 is a diagram illustrating embodiments of an application interface on a receiver device to execute a transaction and transfer funds digitally.

FIG. 7 illustrates an example computer system which can be used to perform currency transfer techniques disclosed herein.

### DETAILED DESCRIPTION

Illustrative embodiments are discussed in detail below. While specific embodiments and drawing illustrations are discussed, it should be understood that this is done for illustration purposes only and not intended as a definition of the limits of the invention. In describing and illustrating the embodiments, specific terminology is employed for the sake of clarity. However, the embodiments are not intended to be limited to the specific terminology so selected. A person skilled in the relevant art will recognize that other components and configurations may be used without departing from the spirit and scope of the embodiments. It is to be understood that each specific element includes all technical equivalents that operate in a similar manner to accomplish a similar purpose. The examples and embodiments described herein are non-limiting examples.

As used herein, the term “a” refers to one or more. The terms “including,” “for example,” “such as,” “e.g.,” “may be” and the like, are meant to include, but not be limited to, the listed examples.

A platform for anonymous electronic transfer of currency is disclosed. The techniques disclosed herein allow strangers to efficiently exchange currency digitally without divulging any personal information (such as name, email, phone number, bank details, and the like) or personalized information (such as tags, nicknames, etc.) to one another. Typically, anonymous currency transfer was only practical using coin and/or paper currency.

In some embodiments, to initiate a transaction, a “giving” user selects or inputs an amount of currency for the transaction (also referred to herein as the “transaction amount” or the “funds” to be transferred) in a device (the “giver device”). Preferably, the giving user inputs the information into an application running on the giver device, e.g., a smartphone, tablet, pager, mobile computing device, etc., having a graphic user interface for inputting data and displaying data (hereinafter an “interface”). The transaction amount may, for example, be in a specified currency, e.g., a U.S. dollar amount, which may be a default currency or a currency entered by the giving user for the specific transaction. A transaction code is generated that is unique for the particular transaction and is to be exchanged between the giving user and the person to receive the transaction amount anonymously (the “receiving user”). In certain cases, the transaction code includes a defined number of graphic characters, e.g., letters, numbers, and/or symbols. For example, the transaction code may include some number, e.g., between two and eight, and more preferably four, of such characters (also referred to herein as “digits”). The transaction code is output on a display at the giving user's device. The transaction code may be valid only within a limited and system-configurable geographic fenced area, for a system-configurable duration, and/or subject to other parameters. A user of the giver device then communicates the transaction code to a receiving user.

According to various embodiments, the receiving user inputs the transaction code into the receiving user's device (the “receiver device”), preferably an application running on the receiver device to execute a transfer of the transaction amount from an account associated with the giving user to an account associated with the receiving user, which accounts have been independently, previously established by the giving and receiving users on the currency transfer platform. The currency transfer platform includes security capabilities to prevent unlawful and unauthorized use. For example, the validity of the transaction code may be determined based on the geographic position of the receiver device, e.g., at the time the transaction was initiated by the giving user or at a later time, and/or other factors. In certain cases, the receiver device must be within a configured perimeter about the giver device at the time the transaction was initiated or at a later time, the receiver device must redeem the transaction amount within a set period of time following the time the transaction was initiated, and/or satisfy other conditions to receive the funds. The transfer of funds may be denied in the case of an invalid data check. In certain cases, once the transaction is completed, the unique transaction code is no longer usable in that geographic area.

However, it should be understood that a unique transaction code associated with a first transaction that is denied or completed may be recycled for use with a subsequent transaction where the conditions and parameters associated with the subsequent transaction would not be confused with the conditions and parameters associated with the first transaction.

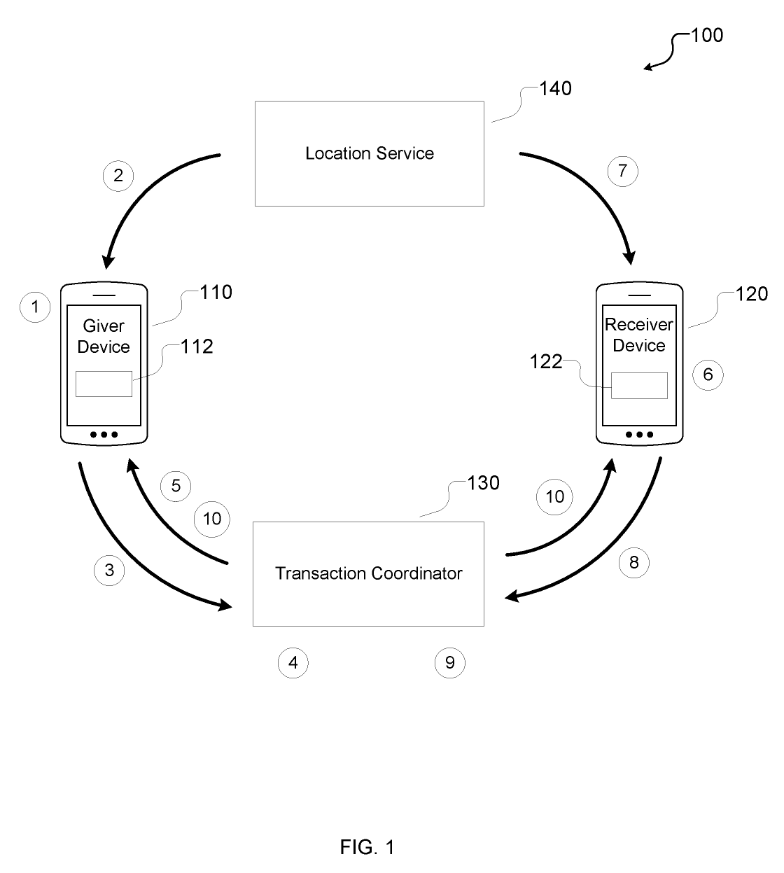

FIG. 1 is a block diagram illustrating embodiments of a currency transfer platform in accordance with the present invention. A currency transfer platform 100 is configured to enable transfer of currency from a giving user to a receiving user. The giving user is associated with a giver device 110, and the receiving user is associated with a receiver device 120. The giver device 110 and receiver device 120 may include mobile devices and/or any other type of computing devices. The giver device 110 and receiver device 120 communicate with a transaction coordinator 130 to transfer currency from an account associated with a giving user of the giver device 110 to an account associated with a receiving user of the receiver device 120. The transaction coordinator 130 may include a server associated with the currency transfer platform 100. The transaction coordinator 130 may include databases and processors executing software to carry out the operations necessary to transfer currency between an account associated with the giver device 110 and an account associated with the receiver device 120. In some embodiments, the giver device 110 includes an application 112 (e.g., giver client application) and/or the receiver device 120 includes an application 122 (e.g., receiver client application) associated with currency platform 100. The giver and receiver client applications 112, 122 are configured to communicate with the transaction coordinator 130 and otherwise carry out the processes disclosed herein.

In various embodiments, an example transaction may include multiple steps. At step one, a user/owner associated with the giver device 110 (the giving user) inputs a transaction amount, i.e., an amount of currency to exchange, in the giver device 110. The currency can be in U.S. dollars, non-U.S. currencies such as yen, Euros, pounds, pesos, cryptocurrency, and/or any other form of legal tender usable as funds, which currency may be preset as a default currency or selected by the user for use in a given transaction.

At step 2, the giver device 110 retrieves location information from a location service 140. The location information can include the location of the giver device 110, such as one or more of GPS coordinates, Global Navigation Satellite Systems (GNSS) location, Global System for Mobile Communications (GSM) location, and/or any other data representing the location of the giver device 110. The giver device 110 may retrieve multiple types of and/or all available location information. In various embodiments, the location information may be associated with an accuracy measure. For example, an application programming interface (API) on the giver device 110 may determine an accuracy of the location information. The accuracy measure may include, for example, ±20 meters, ±one kilometer, ±0.5 miles, and/or any other distance. In certain cases, the location service 140 can include a service associated with a wireless carrier, global positioning system service, and/or any other service to determine a location of the giver device 110. In certain cases, the location service 140 and/or a portion of the location service 140 may be included on the giver device 110.

At step 3, the giver device 110 provides the transaction amount and giver device location information to the transaction coordinator 130. The giver device location may include and/or be derived from the location information provided by the location service 140. In certain cases, the giver device location information includes the position of the giver device 110 and/or an estimated accuracy associated with the position of the giver device 110. In some cases, the giver device location information includes measured positions of the giver device 110 over a period of time (e.g., at the time the transaction is initiated and for a defined period afterward), movement of the giver device 110, a direction of movement, velocity, and/or acceleration of the device 110.

At step 4, the transaction coordinator 130 receives the transaction amount, giver device location information, location accuracy information, and/or other information from the giver device 110. In various embodiments, the transaction coordinator 130 generates a transaction code. The transaction code may include a short code of a number of graphic characters, including, for example, numbers, letters, and/or symbols. In certain cases, the transaction code includes a four digit code and/or any other length digit code. The transaction code may be unique to the transaction, giver device 110, transaction amount, and/or location information. In certain cases, the transaction coordinator 130 may ensure that the same transaction code is not issued to multiple in-progress transactions at the same time. In some instances, the transaction coordinator 130 may ensure that the same transaction code is not used for multiple transactions within a geographic area at the same time. For example, the transaction coordinator may not issue the same and/or similar transaction codes estimated to be within a minimum distance (e.g., 10 miles) of one another. The transaction coordinator may, for example, maintain a list of available and used transaction codes. In other cases, the transaction code is generated randomly for each transaction, and there is some risk the same transaction code could be used for multiple transactions within a given area. In that case, the validity of the transaction can be determined based on other factors discussed herein.

In various embodiments, a digit length of the transaction code may be dependent on a variety of factors, such as the number of users of the platform 100 in the area of the giver device 110, a population density in the area of the giver device 110, and/or other factors. In certain cases, the digit length of the transaction code may be increased in areas of higher population and/or platform user density. The digit length of the transaction code may be shorter in areas of reduced population and/or platform user density. Digit lengths of between two and eight are believed suitable, with a length of four being particularly advantageous because four digits are relatively easy to remember and long enough provide sufficient relative uniqueness within the typical geographic boundary, for example, a crowded tourist resort or hotel, during the time period the transaction code must remain unique.

In various embodiments, the transaction code could include one or more shapes, such as square, rectangle, star, and/or any other shape. As discussed below, the shapes may be entered into a touch responsive interface on the receiver device 120.

In various embodiments, a geographic boundary (also referred to herein as a “geographic fenced area”) is generated based on the location information. The geographic boundary may include an area in which the receiving user is able to receive the funds transfer by, for example, entering the transaction code in receiver device 120, as discussed below. The geographic boundary may include an area surrounding the location of the giver device 110. The geographic boundary may define a perimeter enclosing an area of varying shapes, such as any polygon shape, a circular shape, and/or another shape. In one example, the geographic boundary may include a generally circular area centered at the giver device location, for example, as included in the location information at a defined point in time (e.g., at about the time a transaction code is displayed on a giver device). The geographic boundary may be defined by a radius. In certain cases, the radius may be predetermined and/or default radius for each transaction, such as 100 feet and/or any other distance surrounding the giver device location.

In some embodiments, the radius of the geographic boundary is dynamic. The radius (dynamic radius) may be determined, for example, based on a density of users of the currency transfer platform 100 in the vicinity of the giver device 110. For example, if there are few users of the platform in the general area surrounding the giver device location, the radius may be set to a larger distance to increase the area in which the transaction code can be entered by the receiving user. Conversely, if there are a large number of users of the platform in the general area surrounding the giver device location, the radius may be set to a lower distance to decrease the area. Defining a smaller geographic boundary in an area with many users of the platform may help to ensure the security of the transaction. For example, the likelihood that a non-intended receiving party intercepts the code and is able to successfully enter the code to receive the funds will be reduced in a smaller geographic boundary.

In some cases, the perimeter, and more preferably the radius, is determined based on an accuracy of the giver device location information. For example, if the accuracy of the giver device location information is higher, the radius of the geographic boundary may be set to a relatively low value. If the accuracy of the giver device location information is low, then the radius of the geographic boundary may be set to a higher value to account for the uncertainty. Stated another way, if the potential variance on the location of the giver device is high, the geographic boundary may be increased. Increasing the boundary, in that case, may increase a likelihood the receiver device 120 is within the geographic boundary and is able to successfully execute and receive the funds transfer.

In certain instances, the radius is determined based on a movement, velocity, and/or acceleration of the giver device 110. For example, the giver device location information may include locations of the giver device 110 over a period of time. The giver device location information may be processed to determine a movement, velocity, and/or acceleration of the giver device 110 around the time of the funds transfer. In the event the giver device location information indicates that the giver device 110 is moving, the radius may be increased, e.g., based on the determined velocity and/or acceleration of the giver device since the transaction code was generated. If the giver device 110 is moving, the receiver device 120 may also be moving, and thus expanding the radius will increase the likelihood of a successful transaction. The radius may similarly be increased based on the velocity, acceleration, and/or other dynamics of the giver device 110 and/or the receiver device 120.

In some embodiments, the transaction coordinator 130 determines an expiration time for the transaction code. The expiration time may include a time period in which the transaction code can be entered in a receiver device 120 to execute and complete the funds transfer. In certain cases, the expiration time may be a default period for all transactions, such as five minutes and/or any other period of time. In some instances, the expiration time is determined based on settings defined at the giver device 110. For example, the giver device 110 may allow the giving user to set the time period or override a default time period. The giving user may set the time period based on the context of the transaction. In one example, the giving user may determine that the receiving user is busy and may not have time to immediately enter the transaction code. The giving user may, in that case, set a longer expiration time period. In certain instances, the expiration time is set at the transaction coordinator 130 based on, for example, attributes of the giver device 110, attributes of receiver devices 120 registered with the platform in the area of the giver device 110, population density in the area of the giver device 110, and/or other factors.

In various embodiments, the transaction coordinator 130 generates an exchange object. The exchange object is uniquely associated with the given fund transfer transaction. The exchange object may include the currency amount, transaction code, the geographic boundary information, expiration time information, and/or other information associated with the particular funds transfer. The exchange object may include a data object stored, for example, in a database associated with the transaction coordinator 130.

At step 5, the transaction code is provided to the giver device 110. The transaction code may be displayed in the application 112 on the giver device 110, output by the application using text to speech, and/or otherwise output to a giving user of the giver device 110. In some embodiments, the expiration time may also be provided to the giver device 110. In certain instances, the expiration time is displayed in the application 112 on the giver device 110. In various embodiments, geographic boundary information is provided to the giver device 110. The geographic boundary information may be similarly output by the application 112 on the giver device 110. In certain embodiments, the giving user may be able to adjust the provided expiration time or geographic boundary information.

In various embodiments, the giving user communicates the transaction code to the receiving user of a receiver device 120. For example, the transaction code may be communicated orally, visually by, for example, showing the receiving user the transaction code on the giver device 110, using assistive technologies, and/or other communication approaches.

At step 6, the transaction code is input at the receiver device 120. The transaction code is entered into an interface, for example, in an application 122 on the receiver device 120. In one example, the receiving user types the transaction code into a text entry field on the receiver device 120. In another example, the transaction code is received via audio input, and the speech is converted to text. In a further example, the transaction code includes one or more symbols (e.g., square, star, circle, and the like), and the symbols are input in a touch responsive interface on the receiver device 120.

At step 7, the receiver device 120 retrieves location information from a location service 140. The receiver device location information may be retrieved using the techniques described above with reference to the giver device 110. For example, the receiver device 120 may collect any available location information from the location service 140. The receiver device location information may, in certain instances, be associated with an estimated accuracy.

At step 8, the receiver device 120 provides the transaction code, the receiver device location information, time information (such as a current time), and/or other information to the transaction coordinator 130.

At step 9, the transaction coordinator 130 validates the transaction based on the received transaction code, received device location information, and/or current timestamp. In some embodiments, the transaction coordinator 130 matches the received transaction code, receiver device location information, and/or current time to a stored exchange object. The transaction code and receiver device location information may be compared to exchange objects stored at the transaction coordinator 130. The transaction code may be matched to an exchange object that includes a matching transaction code. The receiver device geographic information may then be compared to the geographic boundary information in that exchange object. In certain cases, the geographic boundary information included in an exchange object may correspond to, satisfy the constraints of, or otherwise match the receiver device location information if the receiver device location information is located with the geographic boundary. In the event the transaction code and receiver device location information match a transaction object, the transaction is validated. If the transaction code and receiver device location to not match any transaction object, the transaction is not validated.

In some embodiments, a timestamp is validated. In certain cases, a time the transaction code is received at the transaction coordinator 130 is compared to an expiration time included in the transaction object. The transaction coordinator 130 may determine whether the expiration time period has lapsed. If the expiration time period has lapsed, the transaction is not validated. In the event the expiration time period has not lapsed, the transaction is validated.

In some embodiments, when a transaction is validated, the funds transfer is executed and the currency amount is transferred from the giving user to the receiving user. In certain cases, the currency amount is transferred from an account registered or associated with the giver device 110 to an account registered or associated with the receiver device 120.

At step 10, information regarding the success or failure of the transaction is provided to the giver device 110 and the receiver device 120. If the transaction was validated, the giver device 110 and receiver device 120 receive information indicating that the transaction was successful. If the transaction failed, the giver device 110 and/or receiver device 120 receive information indicating that the transaction failed. In certain cases, only the receiver device 120 receives information indicating that the transaction failed. The receiver device 120 may display a failure notification and prompt the receiving user to reenter the transaction code. In that case, the process may restart at step 6.

In various embodiments, the process described above may be modified to accommodate various types of transactions. As discussed briefly above, the expiration time may be extended by, for example, the giving user operating the giver device 110 and/or transaction coordinator 130. For example, a giving user may determine that the receiving user does not have the application installed on their device. In that case, the giving user and/or transaction coordinator 130 may extend the expiration period for the transaction code from, for example, a short period (e.g., five minutes) to a longer period (e.g., 24 hours) to allow the receiving user to download the application, register and create an account with the platform 100, enter the transaction code, and redeem the currency amount.

In some embodiments, the geographic boundary may be set to a fixed boundary for any transaction involving a receiver device 120. For example, a receiving user may be an employee at a business, and that employee's receiver device 120 may be permitted to enter transaction codes anywhere within the business property. So, the geographic area may be expanded beyond a default radius of, for example, 100 meters to allow the employee to redeem the transaction anywhere on the business property, even if the perimeter has an irregular shape.

In some embodiments, a receiving device 120 is provided a fixed transaction code that may be used by one or more giver devices 110 to transmit a currency amount to the receiving user's account on the platform 100. For example, the receiver device 120 may be allocated a fixed transaction code associated with a particular receiving user and that person's account. The receiving user of that receiver device 120 may provide the fixed transaction code to a giving user. The giving user enters the fixed transaction code and a currency amount into the giver device 110. The giver device 110 location and the fixed transaction code may be provided to the transaction coordinator 130. In certain cases, the currency amount may then be transferred from the giving user's account to the receiving user's account without the receiving user entering a transaction code into the receiver device. In other cases, when the transaction coordinator 130 receives the fixed transaction code, currency amount and giver device location information from the giver device 110, the transaction coordinator 130 may retrieve a location of the receiver device 120. In the event the receiver device 120 is in the area (e.g., within a predefined distance) of the giver device 110, the transaction is validated and the currency amount is transferred from the giving user account to the receiving user account. In some embodiments, the transaction coordinator 130 may determine whether the receiver device 120 is within a predefined area, such as a house, business, or property. In the event the receiver device 120 is in the area, the transaction may be successful. This implementation may be employed in the context of a service worker that frequently works in the same area (e.g., a hotel, restaurant, and the like). The service worker (here a receiving user) may provide her/his fixed transaction code to various customers (e.g., giving users). The giving users may transfer currency amounts to the worker using the fixed code, and the worker may be able to redeem the funds as long as the work is within the bounds of the business. Should the worker (or another user) attempt to redeem the funds outside of the geographic bounds of the business or beyond an expiration time, the transaction may fail.

In various embodiments, the operations described herein may be performed at any of one or more servers (such as transaction coordinator 130 or other servers), one or more giver devices 110, one or more receiver devices 120, and/or other nodes. For example, operations are described herein as being performed at a server 130 in certain embodiments, but in other embodiments those operations could be performed at the giver device 110 and/or receiver device 120. In some examples, the operations described herein can be performed at multiple components in a currency transfer platform 100. For example, a first portion of an operation could be performed a first device and another portion of the operation could be performed at a second device and/or a server.

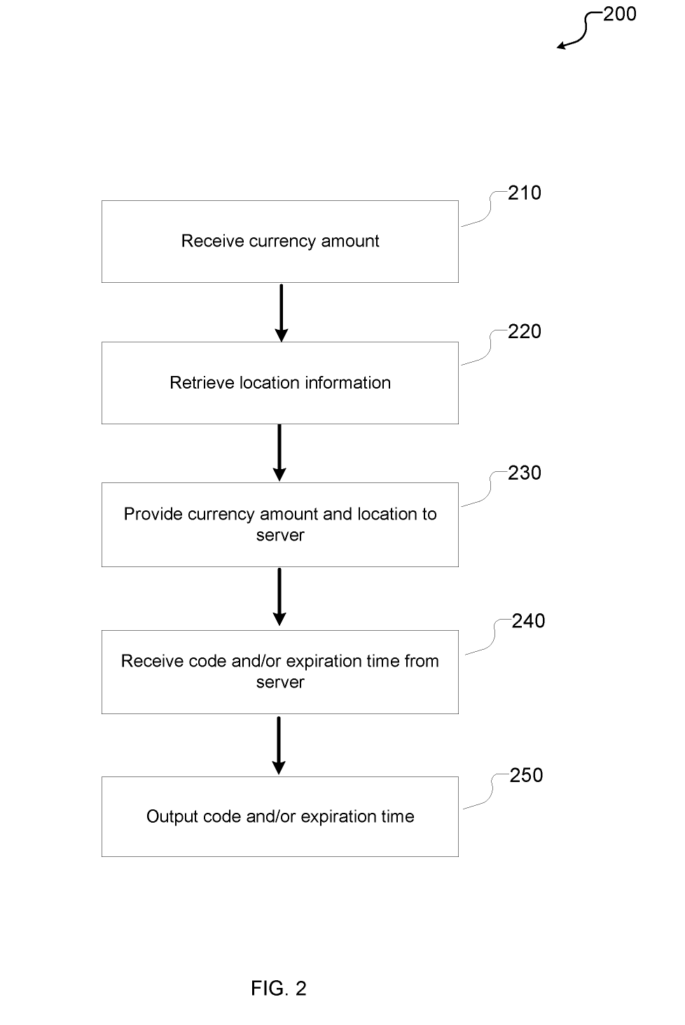

FIG. 2 is a flow diagram illustrating embodiments of a process for transferring currency from a giver device. In some embodiments, the process of FIG. 2 is executed by the giver device 110 and/or giver device application 112 of FIG. 1. In various embodiments, process 200 is performed after a giver device 110 and/or application 112 on the giver device is registered with the currency transfer platform 100.

Once the application and/or giver device are registered, the process 200 may be initiated. In the example shown at step 210, a currency amount is received. The giving user may, for example, open the application, and enter a currency amount (e.g., an amount of U.S. dollars to transfer) into the application interface. In certain cases, the application may include a button and/or other interface to initiate the transaction once the currency amount is entered. At 220, location information for the giver device is retrieved. The giver device may, for example, retrieve location information (e.g., GPS coordinates of the device) from a location service in a conventional manner. The location service may be associated with a wireless carrier. The location information may also be retrieved from a service and/or database on the giver device. In certain instances, the application on the giver device is triggered (programmed) to retrieve the location information when the currency amount is entered and/or the transaction is initiated. In some instances, the application may operate in the background to periodically retrieve location information. Location information may also be simultaneously retrieved from multiple sources.

At step 230, the currency amount, giver device location information, and/or other information are provided to a server, such as transaction coordinator 130 of FIG. 1. The giver device location information may include the current location of the giver device, for example, as retrieved from the location service. The giver device location information may also include information representing the position of the giver device over a period of time, such as five minutes up to the transaction time, five minutes after the transaction time, both, or other periods. In certain cases, the giver device location information can include a velocity of the giver device, acceleration of the giver device, a direction the giver device is moving, and/or other information.

At step 240, a transaction code and (optionally) an expiration code are received from the server. As discussed above, the currency amount, giver device location information, and/or other information from the giver device are processed at the server to generate a transaction code. The transaction code is stored along with geographic boundary information, an expiration time, and/or other information in an exchange object at the server. The transaction code is then sent to the giver device. An expiration time associated with the transaction may, in certain cases, be sent to the giver device.

At step 250, the transaction code is output at the giver device. The transaction code is displayed on the giver device in, for example, an interface in the application, as a message notification, as an audible notification, and/or in any other suitable manner. The giving user may then communicate the transaction code to a receiving user as discussed herein. As noted, the expiration time also may be similarly output to the giver device for display on an application interface. The giving user may also communicate the expiration time to the receiving user and/or modify the expiration time if deemed appropriate in the circumstances of the transaction.

In various embodiments, one or more steps of the process depicted in FIG. 2 may be executed by the receiver device 120 and/or receiver device application 122 of FIG. 1, the transaction coordinator 130 of FIG. 1, and/or any other component in a currency transfer platform.

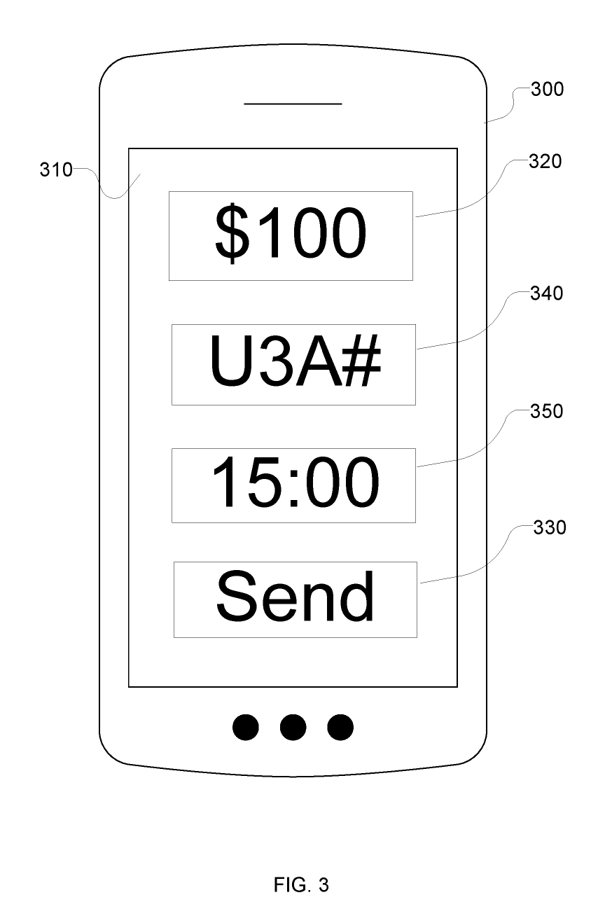

FIG. 3 is a diagram illustrating embodiments of an application interface on a giver device for transferring currency. In the example shown, a giver device 300 (e.g., giver device 110 of FIG. 1) may include an application 310 associated with the currency transfer platform (e.g., currency transfer platform 100 of FIG. 1). The application 310 may include a client application associated with the currency transfer platform. The application 310 communicates with servers on the currency transfer platform. The application 310 can include a currency amount interface 320, such as a text entry field. A giving user of the giver device 300 may enter a currency amount into the currency amount interface 320. In certain cases, a currency transfer operation is initiated when an interface button 330 (e.g., a start button) is activated. As discussed herein the currency amount entered into the currency amount interface 320 is provided along with location information to a server associated with the platform. Upon validation of the currency amount, giver device location information, and/or other processing at the server, a transaction code is sent to the giver device 300. The transaction code is displayed in a transaction code interface 340. In the example shown, the transaction code (e.g., U3A#) is a four digit character code including letters, numbers, symbols, and/or other characters. In certain cases, an expiration time is displayed in an expiration time interface 350. The expiration time may be a time by which the receiving user is required to enter the transaction code. The giving user may communicate the transaction code to a receiving user for entry in the receiving user's device (e.g., receiver device 120 of FIG. 1). Upon successful entry of the transaction code at the receiver device, validation of the code and receiver device location at the server, and/or other operations, a notification may be displayed on the giver device 300 indicating a successful execution of the transaction and that the transfer of the currency amount is complete.

In various embodiments, one or more of the features described in FIG. 3 may be included in a receiver device 120 and/or receiver device application 122 of FIG. 1.

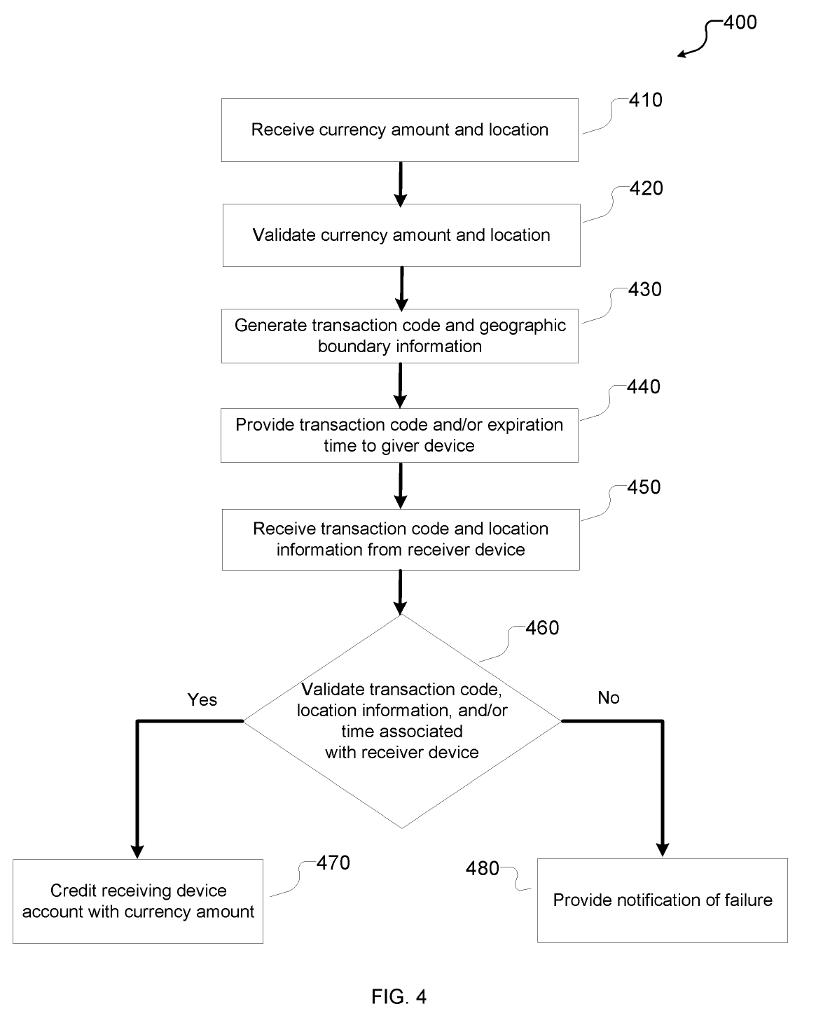

FIG. 4 is a flow diagram illustrating embodiments of a process for transferring currency at a server. In some embodiments, the process 400 is executed by the transaction coordinator 130 of FIG. 1. In the example shown in step 410, a currency amount, giver device location information, and/or other information are received at the server. The server may identify the giver device and/or application that sent the currency amount and giver device location information. In step 420, the currency amount and giver device location are validated. In certain cases, the server validates the currency amount by assessing whether the currency amount is within a predetermined range. For example, if the giver device is typically used to transfer currency within a certain value range and the amount falls outside of that value range, the currency amount may not be validated and a notification may be sent to the giver device. In some instances, the server validates the giver device location information. In one example, the server validates an accuracy of the giver device location information. The server may also evaluate whether the giver device is moving, accelerating, and/or otherwise translating. In the event the movement of the device falls outside of predetermined bounds, the transaction may not be validated and a notification is sent to the giver device. In response to a notification, the giving user may communicate with the service and provide supplemental authentication information in an effort to validate the transaction.

At step 430, a transaction code and geographic boundary information are generated. As described above, the transaction code is generated and stored in an exchange object at the server. The geographic boundary information is generated based on the giver device location and also preferably stored in the exchange object. In certain cases, an expiration time for the transaction is determined and preferably stored in the exchange object. The exchange object may also include the currency amount, an identifier for the giver device, account information associated with the giver device, and/or other information. In certain cases, the exchange object is encrypted at the server.

At step 440, the transaction code and/or expiration time are provided to the giver device. As discussed above, the transaction code and/or expiration code may be displayed on the giver device.

At step 450, a transaction code and receiver device location information are received from a receiver device. In certain cases, the transaction code is communicated from the giving user to the receiving user, the receiving user enters the transaction code in the application on the receiver device, and the transaction code is transmitted by the receiver device to the server. The receiver device may also transmit receiver device location information to the server.

At step 460, the transaction code, receiver device location information, and/or time information are validated. In certain cases, it is determined whether the transaction code matches any transaction codes stored in exchange objects. When a match is determined, the receiver device location information may be compared to the geographic boundary information included in the matched exchange object. For example, if it is determined that the receiver device location is within the geographic boundary included in the exchange object, the transaction may be validated and/or provisionally validated contingent upon also validating other factors. If it is determined that the receiver device location is outside of the geographic boundary, the transaction may not be validated.

In some embodiments, the server further validates the transaction based on a time the transaction code is received from the receiver device. In certain cases, the exchange object includes an expiration time, and the current time is compared to the expiration time period to determine whether the time allotted to complete the transaction has expired. In the event the current time is within an expiration time period, the transaction is validated (also contingent upon also validating other factors). In the event the current time is after the expiration time period, the transaction is invalidated.

In the event the transaction code, receiver device location information, and/or time information are validated, the process proceeds to step 470. In the event the transaction code, receiver device location information, and/or time information are not validated, the process proceeds to step 480.

At step 470, an account associated with the receiver device is credited with the currency amount. Upon validation of the transaction code, receiver device location information, and/or time information, the currency amount may be transferred from an account associated with giver device (e.g., the giving user's account) to an account associated with the receiver device (e.g., the receiving user's account). In certain cases, notifications may be provided to the giving user's and/or receiving user's respective devices to indicate that the transaction was successfully executed and the funds have been transferred. In some instances, the exchange object associated with the transaction is updated to include an indication that the transaction is complete.

At step 480, a notification indicating the transaction failed is provided to the receiver device and/or giver device. In some embodiments, the server sends a notification to the receiver device that the transaction has failed. Based on the notification, the receiver device may output an indication that the transaction failed. In certain cases, a notification indicating the transaction has failed is sent to the giver device. The giver device may then output a notification that the transaction was unsuccessful. The giver device may prompt the giving user to reinitiate the transaction, extend the expiration period, and/or to generate a new transaction.

In various embodiments, the transaction may be voided if the transaction code is not entered within a predetermined period of time. For example, the exchange object may be updated to indicate that the transaction was unsuccessful. In certain cases, if the currency amount had been deducted from the giving user's account pending execution of the transaction by the receiving user, so as to permit the giving user to make additional transactions without the associated account becoming overdrawn, the currency amount for the failed transaction may be restored/refunded to the giving user's account.

In various embodiments, one or more steps of the process of FIG. 4 may be executed by the giver device 110 and/or giver device application 112, the receiver device 120 and/or receiver device application 122 of FIG. 1, and/or any other component of a currency transfer platform.

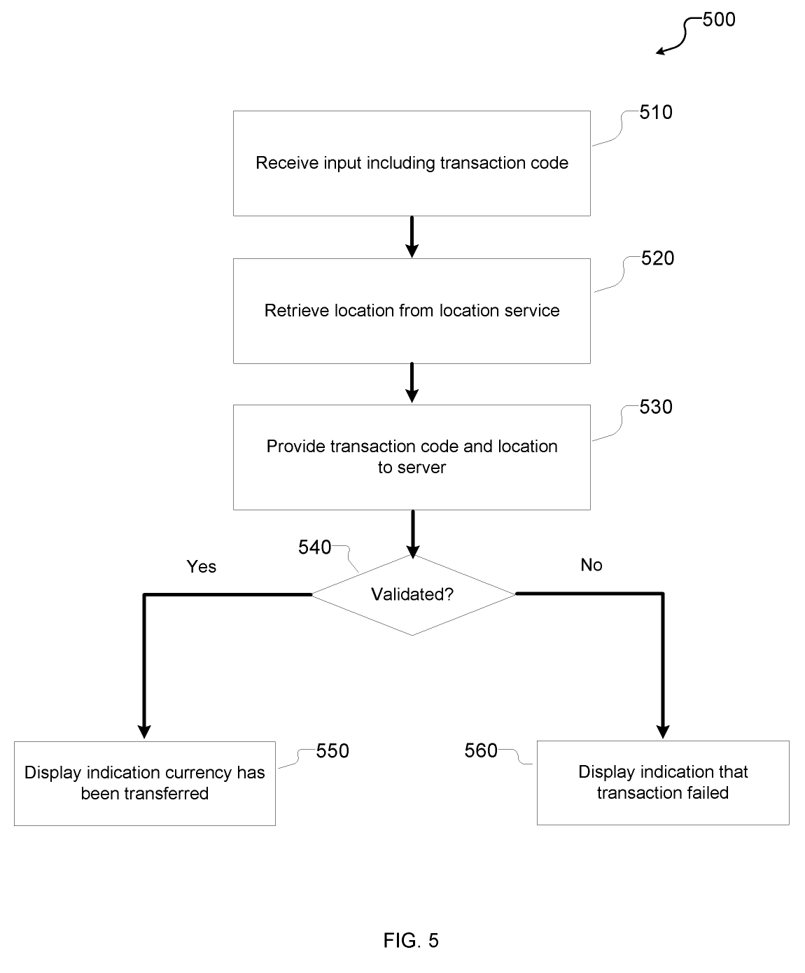

FIG. 5 is a flow diagram illustrating embodiments of a process for receiving funds. In some embodiments, the process 500 is performed at receiver device 120 of FIG. 1. The receiver device may register with the platform using a similar process as the giver device. The process 500 may include the steps performed after the receiver device is registered with platform 100 and after receiving the transaction code from the giving user. In the example shown at step 510, the transaction code is entered at the receiver device. The transaction code may be communicated to the receiving user and entered into receiver device. At step 520, location information for the receiver device is retrieved. The receiver device may, for example, retrieve location information (e.g., GPS coordinates of the device) from a location service (e.g., location service 140 of FIG. 1). In certain instances, the application on the receiver device is triggered (programmed) to retrieve the location information when the transaction code is entered and/or the funds transfer operation is initiated. In some instances, the application may operate in the background to periodically retrieve location information. Location information may also be simultaneously retrieved from multiple sources.

At step 530, the transaction code, receiver device location information, and/or other information are provided to a server, such as transaction coordinator 130 of FIG. 1. The receiver device location information may include the current location of the receiver device, information representing the position of the receiver device over a period of time preceding and/or following a defined timestamp (e.g., the time when the input transaction code was generated), a velocity of the receiver device, acceleration of the receiver device, a direction the receiver device is moving, and/or other location related information.

At step 540, it is determined whether the transaction code, receiver device location information, current time, and/or other information are validated. The information may be validated at the server using, for example, techniques discussed with reference to FIGS. 1 and 4. In the event the transaction is validated, the process proceeds to step 550. In the event the transaction is not validated, the process proceeds to step 560.

At step 550, an indication is output that the currency amount is received. In certain cases, an interface on the application may indicate that the transaction was a success and the currency amount has been added to the receiving user's account. In some instances, the indication may be output by audible notification and/or any other suitable techniques.

At step 560, an indication is output that the transaction was not successful. In certain cases, an interface on the application may indicate that the transaction failed. The receiver device may optionally output a reason for failure, such as code not recognized, time elapsed, invalid location, and/or other reason. At that time, the receiving user may attempt to re-enter the transaction code and the process may begin again at step 510. In the event the receiver device fails multiple times, the receiver device may be locked out from the platform.

In one embodiment, the location of the giver and/or receiver devices may be obtained by an existing location determining service and updated and stored in memory in the respective device(s), unrelated to the platform 100. In such case, the giver device location stored in memory may be grabbed by the giver device application in response to initiation of a transaction, and the receiver device location may be grabbed by the receiver device application in response to input of a transaction code.

In various embodiments, one or more steps of the process of FIG. 5 may be executed by the giver device 110 and/or giver device application 112 of FIG. 1, the transaction coordinator 130 of FIG. 1, and/or any other component of a currency transfer platform.

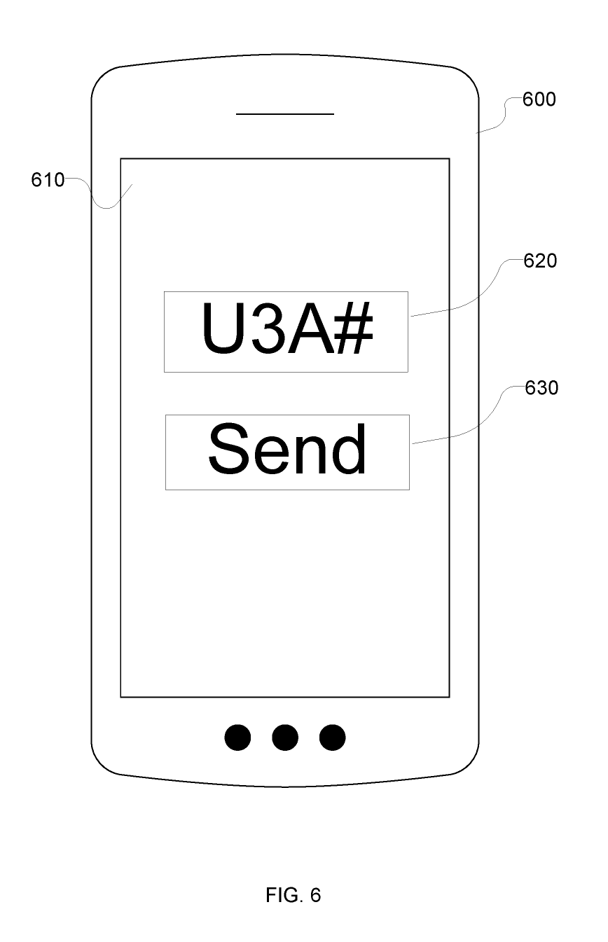

FIG. 6 is a diagram illustrating embodiments of an application interface on a receiver device to execute a transaction and transfer funds digitally. In the example shown, a receiver device 600 (e.g., receiver device 120 of FIG. 1) may include an application 610 associated with the currency transfer platform (e.g., currency transfer platform 100 of FIG. 1). The receiver device application 610 may include similar features and functionality as the giver device application (e.g., giver device application 310 of FIG. 3). The receiver device application 610 and giver device application may include different portions of the same client application. The receiver device application 610 can include a transaction code entry interface 620. The transaction code may be received from the giver user, as discussed herein. In the example shown, the transaction code (e.g., U3A#) is a four digit code including letters, numbers, symbols, and/or other characters. The receiver device application 610 can include an interface 630 (e.g., a button) to the send the transaction code to the server. The transaction code may be sent to the server along with receiver device location information, time information (e.g., a timestamp), and/or other information. Upon successful validation of the transaction code at the server, a notification may be output at the receiver device 600 indicating that the transfer of funds is complete. If the transaction code and other information is not validated, a notification indicating the transaction failed is output at the receiving device 600. The notifications may be character display or audible tones having associated defined meanings.

### Example Implementations

In various embodiments, the techniques disclosed herein may be used in the following exemplary and non-limiting environments. In a first example environment, the techniques may be used to execute a Give and Get transaction. In certain cases, the “Giving User” may select/enter the currency amount she/he would like to give to the “Getting User” (i.e., the receiving user) and enter the currency amount through an interface into an application on a mobile device (e.g., a smartphone or tablet). The application communicates with a server, which then generates a temporally unique transaction code (e.g., between 3 and 8 digits, more preferably 4 digits) that will be returned to the application and displayed on the giving user's screen (application interface); the receiving user will then input that code in his/her device application to execute the funds transfer on validation of the conditions of the transaction. Once this process is successfully completed, or determined to have failed, the giving and receiving users' screen will be updated accordingly, e.g., to reflect the successful transfer of funds and optionally the new balances of the users' accounts, or the failure of the transaction.

In certain embodiments, the giving user and receiving user each can designate a currency in which to maintain their accounts associated with the currency transfer platform, and the currency transfer platform is configured to allow for other currencies to be selected for a given transaction, and to convert the currency from one form (e.g., U.S. dollars) to another (e.g., Euros) as needed, using internationally accepted standards to make currency conversions based on the time and date of the transaction, as needed. This conversion can be transparent to the users, such that a giving user whose account is maintained in U.S. dollars, may transfer funds valued in U.S. dollars, Euros, or other currencies, but the giving user's account will show the currency amounts transferred in corresponding U.S. dollar amounts. Likewise, if the receiving user conducts transactions in Euros, the receiving user's accounts may show the currency value in Euros, even if the giving user transferred the funds in U.S. dollars or some other currency.

In certain cases, neither of these Give and Get transaction users (giver or receiver) needs or will have access to any of the other user's contact information, though internally, the currency transfer platform may confidentially record and hold the records of the users involved in each transaction. The only record of the transaction available to the users will be information regarding the currency amount, the date/time, and perhaps information describing the transaction (e.g., a tip for services rendered, as might be used for reimbursement on an expense account). This use case is well-suited to providing tips to, for example, a parking attendant, assistant at hotel, wait staff at a restaurant, etc. In today's service economy, it is customary in many countries to tip service providers by payment of money over and above their normal wages. In many circumstances, tipping is done spontaneously, instantaneously and/or anonymously. Rather than carrying coins and/or small denomination bills or worrying about converting money from one currency to another while traveling internationally, the currency transfer platform disclosed herein allows for easy, spontaneous, instantaneous, and anonymous transfer of currency amounts digitally.

In a second example environment, the techniques can be used to transfer funds to a micro merchant. In various embodiment, the purchaser and the merchant must have the application installed. Similar to a cash transaction, at the moment when a payment is due, the merchant (the receiving user in this embodiment) will tell the user the amount they need to pay and the buyer (the giving user in this embodiment) will simply select/enter the currency amount he/she need to pay, and the currency transfer platform application will immediately generate a temporally unique transaction code that will be displayed on the buyer's device screen; the merchant will then input that transaction code in his/her device to execute the funds transfer. Once this process is successfully completed, the buyer's and merchants' respective device screens will be updated to reflect the successful transaction, and optionally their new account balances.

### Exemplary Computer Architecture

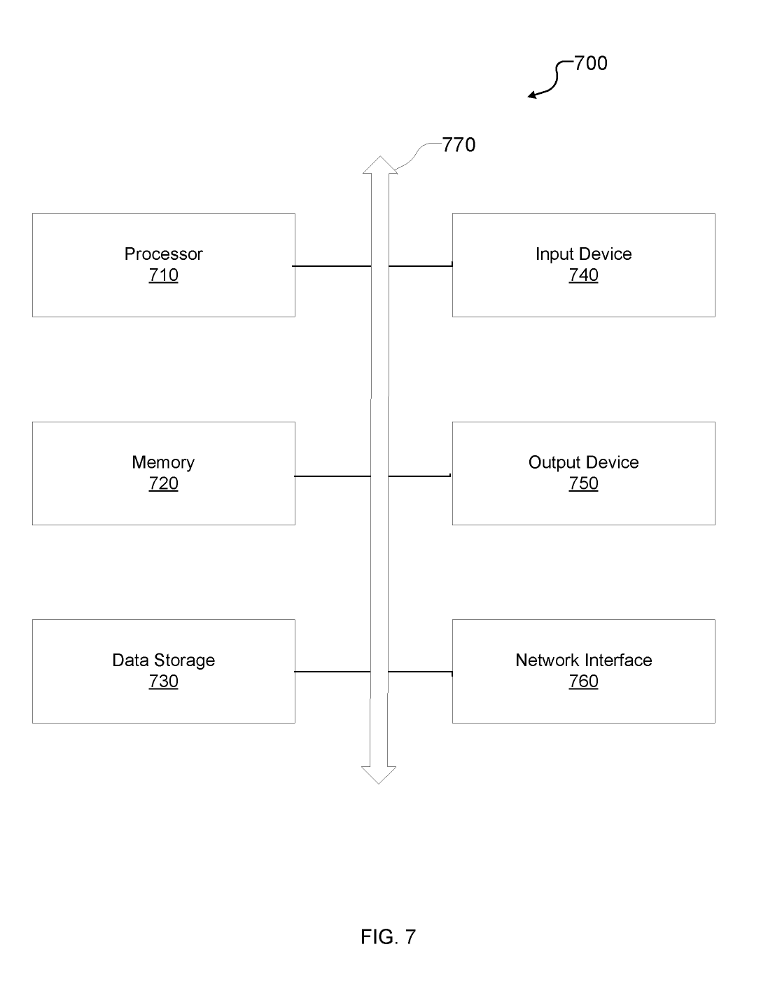

FIG. 7 illustrates an example computer system which can be used to perform currency transfer techniques disclosed herein. Computer system 700 can be giver device 110 of FIG. 1, receiver device 120 of FIG. 1, transaction coordinator 130 of FIG. 1, location service 140 of FIG. 1, and/or any other computing systems contemplated by the present disclosure. With reference to FIG. 7, computing system 700 includes one or more processors 710, one or more memories 720, one or more data storages 730, one or more input devices 740, one or more output devices 750, network interface 760, one or more optional peripheral devices, and a communication bus 770 for operatively interconnecting the above-listed elements. Processors 710 can be configured to implement functionality and/or process instructions for execution within computing system 700. For example, processors 710 may process instructions stored in memory 720 or instructions stored on data storage 730. Such instructions may include components of an operating system or software applications necessary to implement the methods for currency transfer as described above.

Memory 720 can be configured to store information within computing system 700 during operation. For example, memory 720 can store instructions to perform the methods for initiating, validating and transferring funds as described herein. Memory 720, in some example embodiments, may refer to a non-transitory computer-readable storage medium or a computer-readable storage device. In some examples, memory 720 is a temporary memory, meaning that a primary purpose of memory 720 may not be long-term storage. Memory 720 may also refer to a volatile memory, meaning that memory 720 does not maintain stored contents when memory 720 is not receiving power. Examples of volatile memories include RAM, dynamic random access memories (DRAM), static random access memories (SRAM), and other forms of volatile memories known in the art. In some examples, memory 720 is used to store program instructions for execution by processors 710. Memory 720, in one example, is used by software applications or mobile applications. Generally, software or mobile applications refer to software applications suitable for implementing at least some operations of the methods as described herein.

Data storage 730 can also include one or more transitory or non-transitory computer-readable storage media or computer-readable storage devices. For example, data storage 730 can store instructions for processor 710 to implement the methods described herein. In some embodiments, data storage 730 may be configured to store greater amounts of information than memory 720. Data storage 730 may be also configured for long-term storage of information. In some examples, data storage 730 includes non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Computing system 700 may also include one or more input devices 740. Input devices 740 may be configured to receive input from a user through tactile, audio, video, or biometric channels. Examples of input devices 740 may include a keyboard, keypad, mouse, trackball, touchscreen, touchpad, microphone, video camera, image sensor, fingerprint sensor, iris scanner, scanner, or any other device capable of detecting an input from a user or other source, and relaying the input to computing system 700 or components thereof.

Output devices 750 may be configured to provide output to a user through visual or auditory channels. Output devices 750 may include a video graphics adapter card, display, such as liquid crystal display (LCD) monitor, light emitting diode (LED) monitor, or organic LED monitor, sound card, speaker, lighting device, projector, or any other device capable of generating output that may be intelligible to a user. Output devices 750 may also include a touchscreen (also referred to as touch-sensitive or touch-responsive displays), presence-sensitive display, or other input/output capable displays known in the art.

Computing system 700 can also include network interface 760. Network interface 760 can be utilized to communicate with external devices via one or more communications networks such as a communications network or any other wired, wireless, or optical networks. Network interface 760 may be a network interface card, such as an Ethernet card, an optical transceiver, a radio frequency transceiver, or any other type of device that can send and receive information.

An operating system of computing system 700 may control one or more functionalities of computing system 700 or components thereof. For example, the operating system may interact with the software or mobile applications and may facilitate one or more interactions between the software/mobile applications and processors 710, memory 720, data storages 730, input devices 740, output devices 750, and network interface 760. The operating system may interact with or be otherwise coupled to software applications or components thereof. In some embodiments, software applications may be included in the operating system.

Present techniques may be implemented using a variety of technologies, including computer software, electronic hardware, or a combination thereof, depending on the application. Electronic hardware can refer to a processing system, such as a computer, workstation or server that includes one or more processors. Examples of processors include microprocessors, microcontrollers, Central Processing Units (CPUs), digital signal processors (DSPs), field programmable gate arrays (FPGAs), programmable logic devices (PLDs), state machines, gated logic, discrete hardware circuits, and other suitable hardware configured to perform various functions described throughout this disclosure. The term “processor” is intended to include systems that have a plurality of processors that can operate in parallel, serially, or as a combination of both, irrespective of whether they are located within the same physical localized machine or distributed over a network. A network can refer to a local area network (LAN), a wide area network (WAN), and/or the Internet. One or more processors in the processing system may execute software, firmware, or middleware (collectively referred to as “software”). The term “software” shall be construed broadly to mean instructions, instruction sets, code, code segments, program code, programs, subprograms, software components, applications, software applications, mobile applications, software packages, routines, subroutines, objects, executables, threads of execution, procedures, functions, etc., whether referred to as software, firmware, middleware, microcode, hardware description language, and the like. If the embodiments of this disclosure are implemented in software, it may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage, solid state memory, or any other data storage devices, combinations of the aforementioned types of computer-readable media, or any other medium that can be used to store computer executable code in the form of instructions or data structures that can be accessed by a computer.

The above mentioned and described embodiments are only given as examples and should not be seen to be limiting to the present invention. Other solutions, uses, objectives, and functions within the scope of the invention as claimed in the below described patent claims should be apparent for the person skilled in the art.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may. The various embodiments described herein may be combined and/or features of the embodiments may be combined to form new embodiments.

Unless specifically stated otherwise, as apparent from the following discussions, it is appreciated that throughout the specification discussions utilizing terms such as “processing,” “computing,” “calculating, ” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors and/or databases.

Embodiments of the invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product, such as, for example, a scientific modeling product. It may be downloadable from a network, for example, a website, as a stand-alone product or as an add-in package for installation in an existing software application. It may also be available as a client-server software application, or as a web-enabled software application. One or more computers may be specialized by storing programming logic that enables one or more processors to perform the techniques indicated herein. As used herein, the term “application” may be one or more of the foregoing software embodiments installed on a user's device and intended to interact with a remote server.

While various embodiments of the invention have been described above, it should be understood that they have been presented by way of example only, and not limitation. Thus, the breadth and scope of the invention should not be limited by any of the above-described illustrative embodiments. The embodiments of the invention that have been described above may contain features that may be removed or combined between the described embodiments to derive additional embodiments.

What is claimed is:

1. A system to transfer a currency amount from a giving user account associated with a giver device to a receiving user account, comprising:
the giver device including a processor and a memory coupled to the processor and configured to provide the processor with instructions, and a system for communicating with remote computing devices, the instructions comprising:
generate a first application interface to receive a currency amount to be transferred;
determine a location information corresponding to a geographic location of the giver device associated with an input of the currency amount;
provide the currency amount and the location information to a remote server and in response thereto receive a transaction code;
generate a second application interface and output the transaction code to the second application interface; and
receive from the remote server one of a first notification that the currency amount was transferred and a second notification that the currency amount was not transferred.

2. The system of claim 1, wherein the instructions further comprise:
determine an expiration time to complete the transfer at least partially in response to data entered at the giver device; and
provide the expiration time to the remote server.

3. The system of claim 2, wherein, in response to the second notification corresponding to the expiration time elapsing before the currency amount was transferred, the instructions further comprising:
generate a third application interface to receive an input including an increased expiration time to complete said transfer of the currency amount; and
provide the increased expiration time to the remote server.

4. The system of claim 1, wherein the second application interface and output comprise one of a visual display of the transaction code and an audible output of the transaction code using text to speech.

5. The system of claim 1, wherein the location information comprises a geographic boundary information including an area centered at the geographic location of the giver device and bounded by a radius.

6. The system of claim 5, wherein the radius is calculated based at least in part on one or more of a density of users of a currency transfer platform, an estimated error associated with the location information, and a movement associated with the giver computing device.

7. The system of claim 1, wherein a length of the transaction code is determined based at least in part on one or more of a density of users of a currency transfer platform, an estimated error associated with the location information, and a movement associated with the giver device.

8. The system of claim 1, wherein the location information includes global positioning system (GPS) locations generated by a location service.

9. The system of claim 1, wherein the transaction code includes four digits of alphanumeric characters.

10. A computer-implemented method to transfer a currency amount from a giving user account associated with a giver device to a receiving user account, the method comprising:
generating, at the giver device, a first application interface to receive a currency amount to be transferred;
determining, at the giver device, a location information corresponding to a geographic location of the giver device associated with an input of the currency amount;
providing, at the giver device, the currency amount and location information to a remote server and in response thereto receiving a transaction code;
generating, at the giver device, a second application interface and outputting the transaction code to the second application interface; and
receiving, at the giver device from the remote server, one of a first notification that the currency amount was transferred and a second notification that the currency amount was not transferred.

11. The method of claim 10, further comprising:
determining an expiration time to complete the transfer at least partially in response to data entered at the giver device; and
providing the expiration time to the remote server.

12. The method of claim 11, wherein, in response to the second notification corresponding to the expiration time elapsing before the currency amount was transferred, the method further comprising:
generating a third application interface to receive an input including an increased expiration time to complete said transfer of the currency amount; and
providing the increased expiration time to the remote server.

13. The method of claim 10, wherein the second application interface and output comprises one of a visual display of the transaction code and an audible output of the transaction code using text to speech.

14. The method of claim 10, wherein the first location information comprises a geographic boundary information including an area centered at the geographic location of the giver device and bounded by a radius.

15. The method of claim 14, wherein the radius is calculated based at least in part on one or more of a density of users of a currency transfer platform, an estimated error associated with the location information, and a movement associated with the giver device.

16. A computer program product to transfer a currency amount from a giving user account associated with a giver device to a receiving user account, the computer program product being embodied in a non-transitory computer readable storage medium and comprising computer instructions for:
generating, at the giver device, a first application interface to receive a currency amount to be transferred;
determining, at the giver device, a location information corresponding to a geographic location of the giver device associated with an input of the currency amount;
providing, at the giver device, the currency amount and location information to a remote server and in response thereto receiving a transaction code;
generating, at the giver device, a second application interface and outputting the first transaction code to the second application interface; and
receiving, at the giver device from the remote server, one of a first notification that the currency amount was transferred and a second notification that the currency amount was not transferred.

17. The computer program product of claim 16, wherein the instructions further comprise instructions for:
determining an expiration time to complete the transfer at least partially in response to data entered at the giver device; and
providing the expiration time to the remote server.

18. The computer program product of claim 17, wherein, in response to the second notification corresponding to the expiration time elapsing before the currency amount was transferred, the instructions further comprising:
generating a third application interface to receive an input including an increased expiration time to complete said transfer of the currency amount; and
providing the increased expiration time to the remote server.

19. The computer program product of claim 16, wherein the location information comprises a geographic boundary information including an area centered at the geographic location of the giver device and bounded by a radius.

20. The computer program product of claim 19, wherein the radius is calculated based at least in part on one or more of a density of users of a currency transfer platform, an estimated error associated with the location information, and a movement associated with the giver device.
